(19) United States
(12) Patent Application Publication
(10) Pub. No.: US 2026/0318403 A1
(43) Pub. Date: Oct. 15, 2026

(54) VEHICLE DRIVE DEVICE

(71) Applicant: JTEKT CORPORATION, Kariya-shi (JP)

(72) Inventors: Yasuhiko HAZAMA, Kashihara-shi (JP); Atsushi ANDO, Kariya-shi (JP); Noriyuki FUJII, Hekinan-shi (JP); Koji KIMURA, Nagoya-shi (JP)

(73) Assignee: JTEKT CORPORATION, Kariya-shi (JP)

(21) Appl. No.: 19/482,833

(22) PCT Filed: Jun. 19, 2023
(86) PCT No.: PCT/JP2023/022582

§ 371 Date: Nov. 10, 2025

(51) Int. Cl. F16H 57/04; B60K 7/00; B60K 17/04; F16H 37/04; F16H 57/02; F16H 57/027

(52) U.S. Cl. CPC F16H 57/0486; B60K 7/0007; B60K 17/046; F16H 37/041; F16H 57/027; F16H 57/043; F16H 57/045; F16H 57/0457; B60K 2007/0061; F16H 2057/02034; F16H 2057/02052

(57) ABSTRACT

A vehicle drive device for driving a wheel-tire assembly of a vehicle, including a motor, a reduction gear mechanism lubricated by lubricating oil, and a case that houses at least part of the reduction gear mechanism. The reduction gear mechanism includes an input gear and an output gear. The output gear includes a large diameter gear portion having a cylindrical shape with a diameter larger than a diameter of the input gear, a shaft portion having an outside diameter smaller than an outside diameter of the large diameter gear portion, and a disk portion provided between the large diameter gear portion and the shaft portion. The input gear is meshed with the large diameter gear portion. Part of the case is disposed on an inner side of the large diameter gear portion. A reservoir that stores the lubricating oil is provided in the part of the case.

### TECHNICAL FIELD

The present invention relates to a vehicle drive device that drives wheel-tire assemblies of a vehicle.

### BACKGROUND ART

A so-called in-wheel motor system has been proposed as a drive system for electric vehicles using a motor as a drive source, in which wheel-tire assemblies are driven by drive devices disposed inside wheels of the wheel-tire assemblies. Vehicles that employ this type of drive system have high acceleration response due to the distance between drive sources and the wheel-tire assemblies being short, and also independently controlling drive force of the right and left wheel-tire assemblies enables turning ability to be improved, and so forth.

Patent Literature 1 describes a motor drive unit that reduces output rotations of a motor using a high-speed reduction mechanism and a low-speed reduction mechanism, and drives a wheel-tire assembly so as to rotate using running torque of the motor amplified by this reduction. The high-speed reduction mechanism is made up of a parallel shaft gear pair, and the low-speed reduction mechanism is made up of a planetary gear reduction mechanism. The parallel shaft gear pair and the planetary gear reduction mechanism are housed in a reducer chamber surrounded by a motor case and a reducer case. An oil reservoir is provided at a bottom portion of the reducer chamber, and is divided by a partition plate into a high-speed reduction mechanism side reservoir and a low-speed reduction mechanism side reservoir. The parallel shaft gear pair is lubricated by oil stored in the high-speed reduction mechanism side reservoir, and the planetary gear reduction mechanism is lubricated by oil stored in the low-speed reduction mechanism side reservoir.

### CITATION LIST

### Patent Literature

Patent Literature 1: JP 2015-132315 A

### SUMMARY OF INVENTION

### Technical Problem

An in-wheel motor system drive device is disposed inside a wheel of a wheel-tire assembly, and accordingly there is a need to be small in size. In a configuration described in Patent Literature 1, the oil reservoir is provided at the bottom portion of the reducer chamber, which results in the motor case and the reducer case becoming larger in size. Also, the increase in size of these cases leads to increase in weight of the device, and accordingly there is a concern that the increase in weight of the device may result in poorer electric mileage performance.

Accordingly, an object of the present invention is to provide a vehicle drive device that can be made smaller and lighter.

### Solution to Problem

In order to achieve the above-mentioned object, the present invention provides a vehicle drive device for driving a wheel-tire assembly of a vehicle, comprising a motor, a reduction gear mechanism lubricated by lubricating oil, and a case that houses at least part of the reduction gear mechanism, wherein the reduction gear mechanism comprises an input gear and an output gear, wherein the output gear comprises a large diameter gear portion having a cylindrical shape with a diameter larger than a diameter of the input gear, a shaft portion having an outside diameter smaller than an outside diameter of the large diameter gear portion, and a disk portion provided between the large diameter gear portion and the shaft portion, wherein the input gear is meshed with the large diameter gear portion, wherein part of the case is disposed on an inner side of the large diameter gear portion, and wherein a reservoir that stores the lubricating oil is provided in the part of the case.

### Advantageous Effects of Invention

According to the present invention, the vehicle drive device can be made smaller and lighter.

### BRIEF DESCRIPTION OF DRAWINGS

FIG. 1 is a perspective view illustrating a drive device, a wheel-tire assembly, an attaching member, a brake disc, and a brake device, according to an embodiment of the present invention.

FIG. 2 is a cross-sectional view of the drive device and surroundings thereof.

FIG. 3 is a partially enlarged view of FIG. 2.

FIG. 4 is a perspective view illustrating a holding member and one support shaft member.

FIG. 5 is a perspective view illustrating a linking member.

FIG. 6 is a cross-sectional view of the drive device, illustrating a cross-section of a planetary gear mechanism perpendicular to an axial direction, as viewed from a vehicle inner side toward a vehicle outer side.

FIG. 7 is a perspective cross-sectional view illustrating an outward member.

FIG. 8A is a configuration diagram illustrating a case.

FIG. 8B is a cross-sectional view taken along line A-A in FIG. 8A.

FIG. 9 is a perspective view of the case.

FIG. 10A is a diagram illustrating a configuration of a reduction gear.

FIG. 10B is a cross-sectional view of the reduction gear, viewing a cross-section of a shaft portion of the reduction gear from the vehicle outer side toward the vehicle inner side.

FIG. 11 is a cross-sectional view illustrating a case and a reduction gear according to a modification.

### DESCRIPTION OF EMBODIMENTS

### Embodiment

An embodiment of the present invention will be described with reference to the drawings. Note that the embodiment described below is shown as a suitable specific example for carrying out the present invention, and while some portions of the embodiment specifically exemplify various technically preferable technical matters, the technical scope of the present invention is not limited to such specific aspects.

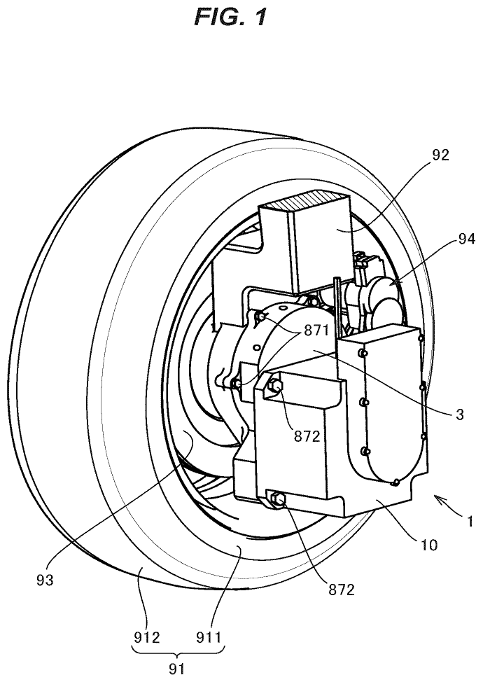

FIG. 1 is a perspective view illustrating a drive device 1 according to the embodiment of the present invention, a wheel-tire assembly 91 that is driven by the drive device 1, an attaching member 92 to which the drive device 1 is attached, a brake disc 93 that rotates integrally with the wheel-tire assembly 91, and a brake device 94. The wheel-tire assembly 91 includes a wheel 911 that is made of metal, and a tire 912 that is made of rubber and is attached to the wheel 911. The attaching member 92 is linked to a body of a vehicle via a suspension arm, a shock absorber, and a suspension spring. The brake device 94 generates braking force by pressing brake pads against the brake disc 93.

The operation of each component of the drive device 1 is lubricated by lubricating oil sealed in the drive device 1. The configuration and operation of the drive device 1 will be described below, following which a flow of lubricating oil within the drive device 1 will be described.

### Lubrication Structure of Drive Device 1

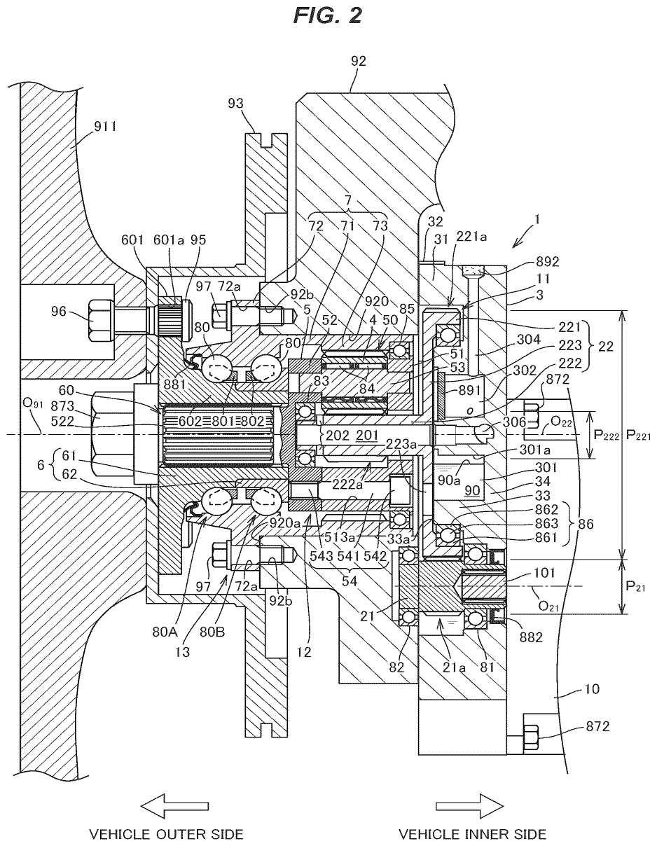

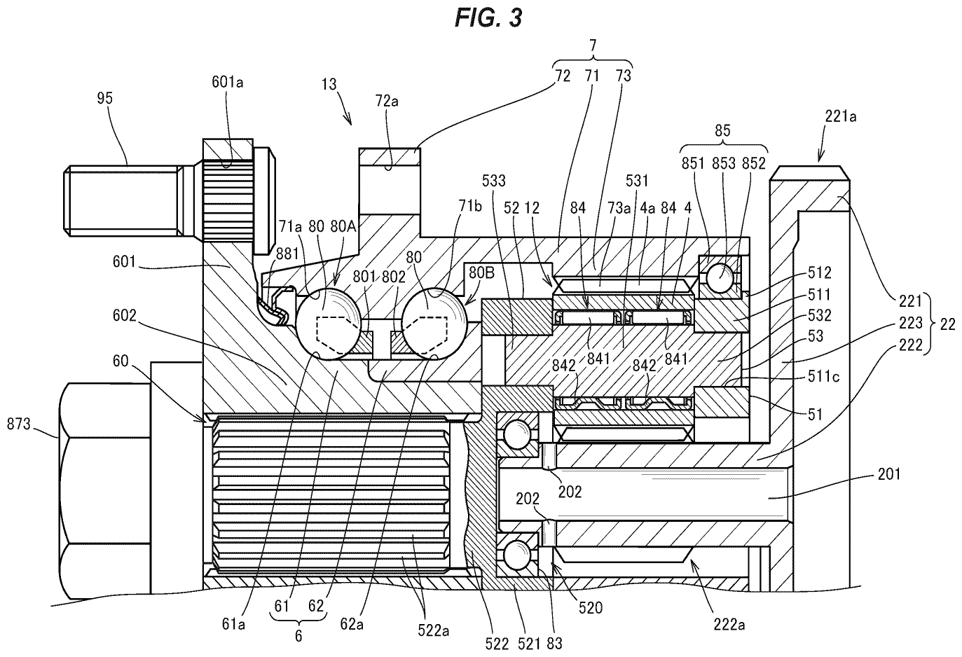

FIG. 2 is a cross-sectional view of the drive device 1 and surroundings thereof. FIG. 3 is a partially enlarged view of FIG. 2. In FIG. 2, upward in the drawing corresponds to upward in a vertical direction, and downward in the drawing corresponds to downward in the vertical direction. In the following description, the terms “up” and “down” refer to the up and down in the vertical direction in a state in which the drive device 1 is installed in the vehicle.

In FIG. 2, a rotation axis O₉₁ of the wheel-tire assembly 91 is indicated by a long dashed short dashed line. The attaching member 92 has an attaching hole 920 formed therein for attaching the drive device 1. The attaching hole 920 is a circular hole formed coaxially with the rotation axis O₉₁, and passes through the attaching member 92.

Hereinafter, the wheel-tire assembly 91 side of the attaching member 92 will be referred to as “vehicle outer side”, and the opposite side will be referred to as “vehicle inner side”.

The drive device 1 includes, as functional components thereof, a motor 10, a reduction gear mechanism 11 and a planetary gear mechanism 12 that reduce the speed of output rotations of the motor 10, and a hub unit 13 that supports the wheel-tire assembly 91. The planetary gear mechanism 12 and the hub unit 13 are aligned along the rotation axis O₉₁, and are disposed coaxially. The reduction gear mechanism 11 is provided between the motor 10 and the planetary gear mechanism 12. The reduction gear mechanism 11 functions as a primary reduction mechanism that reduces the output rotations of the motor 10. The planetary gear mechanism 12 includes a plurality of planetary gears 4 and functions as a secondary reduction mechanism that further reduces output rotations of the reduction gear mechanism 11.

The reduction gear mechanism 11, the planetary gear mechanism 12, and the hub unit 13 are lubricated by lubricating oil 90. The lubricating oil 90 is made by adding additives to a base oil made of, for example, mineral oil or synthetic oil, to improve and maintain lubricating performance.

The drive device 1 also includes, as main components thereof, a pinion gear 21 that is attached to an output shaft 101 of the motor 10, a reduction gear 22 with a large diameter that is meshed with the pinion gear 21, a case 3 that houses at least part of the reduction gear mechanism 11, the plurality of planetary gears 4 that makes up the planetary gear mechanism 12, a carrier 5 that supports the plurality of planetary gears 4, an inward member 6 that rotates integrally with the carrier 5, an outward member 7 that is fit and fixed in the attaching hole 920, a plurality of rolling elements 80 that is disposed between the inward member 6 and the outward member 7, and bearings 81 to 86.

As illustrated in FIG. 1, the case 3 is fixed to the attaching member 92 by a plurality of bolts 871. The motor 10 is an electric motor that generates torque to rotate the output shaft 101 by a drive current supplied from a control unit that is omitted from illustration, and more specifically, is, for example, an interior permanent magnetic synchronous motor or a surface permanent magnet synchronous motor. The motor 10 is fixed to the case 3 by a plurality of bolts 872.

The reduction gear mechanism 11 is configured to include the pinion gear 21 and the reduction gear 22. The pinion gear 21 corresponds to an input gear according to the present invention, and the reduction gear 22 corresponds to an output gear according to the present invention. The reduction gear mechanism 11 reduces the speed of rotation of the pinion gear 21 to amplify the torque of the motor 10, and outputs the torque from the reduction gear 22 to the planetary gear mechanism 12.

The planetary gear mechanism 12 is made up of the plurality of planetary gears 4, the carrier 5, and part of the outward member 7. The hub unit 13 is made up of the inward member 6, the plurality of rolling elements 80, and part of the outward member 7. The planetary gear mechanism 12 further reduces the output rotations of the motor 10 that have been reduced by the reduction gear mechanism 11, and performs output thereof from the carrier 5 to the inward member 6. The inward member 6 is rotatably supported on the outward member 7 by the plurality of rolling elements 80, and rotates integrally with the wheel-tire assembly 91. The components of the drive device 1 will be described below in detail.

The pinion gear 21 is attached to the output shaft 101 of the motor 10 so as to be unable to rotate relative to the output shaft 101. An end portion of the pinion gear 21 on the vehicle inner side is rotatably supported by the bearing 81 held in the case 3. The end portion of the pinion gear 21 on the vehicle outer side is rotatably supported by the bearing 82 held by the attaching member 92. The pinion gear 21 includes a small diameter gear element 21a made of a spur gear between the bearing 81 and the bearing 82. FIG. 2 illustrates a pitch circle diameter P₂₁ of the small diameter gear element 21a. FIG. 2 also indicates a rotation axis O₂₁ of the pinion gear 21 by a long dashed short dashed line.

The reduction gear 22 integrally includes a large diameter gear portion 221 having a cylindrical shape with a larger diameter than the pinion gear 102, a shaft portion 222 with an outside diameter smaller than that of the large diameter gear portion 221, and a disk portion 223 provided between the large-diameter gear portion 221 and the shaft portion 222. In FIG. 2, a rotation axis O₂₂ of the reduction gear 22 is indicated by a long dashed short dashed line. The rotation axis O₂₂ of the reduction gear 22 matches with the rotation axis O₉₁ of the wheel-tire assembly 91. The rotation axis O₂₁ of the pinion gear 21 is parallel to the rotation axis O₂₂ of the reduction gear 22. The pinion gear 21 is disposed downward from the rotation axis O₂₂ of the reduction gear 22, and meshes with the large diameter gear portion 221 at a lower end portion of the reduction gear 22. Hereinafter, a direction parallel to the rotation axis O₂₂ of the reduction gear 22 will be referred to as “axial direction”.

The large diameter gear portion 221 extends in the axial direction from an outer peripheral end portion of the disk portion 223 toward the vehicle inner side. The large diameter gear portion 221 is formed with a large diameter gear element 221a made of a spur gear that meshes with the small diameter gear element 21a of the pinion gear 21. A pitch circle diameter P₂₂₁ of the large diameter gear element 221a is formed to be larger than a pitch circle diameter P₂₁ of the small diameter gear element 21a.

The shaft portion 222 extends in the axial direction from an inner peripheral end portion of the disk portion 223 toward the vehicle outer side, and is disposed in a center portion of the planetary gear mechanism 12. The plurality of planetary gears 4 is disposed on an outer periphery of the shaft portion 222. The shaft portion 222 is formed with a sun gear element 222a that meshes with the plurality of planetary gears 4. The sun gear element 222a is made up of helical teeth of which tooth traces are inclined relative to the axial direction. A pitch circle diameter P₂₂₂ of the sun gear element 222a is formed to be smaller than a pitch circle diameter P₂₂₁ of the large diameter gear element 221a.

The carrier 5 is configured to include a holding member 51 with a plurality of holding portions 50 formed thereon, each holding the plurality of planetary gears 4, a linking member 52 that prevents the planetary gears 4 from slipping out of the holding portions 50 and that also links the holding member 51 to the inward member 6, a plurality of support shaft members 53 that is disposed between the holding member 51 and the linking member 52 and that supports each of the plurality of planetary gears 4, and a plurality of bolts 54 that fixes the holding member 51 to the linking member 52.

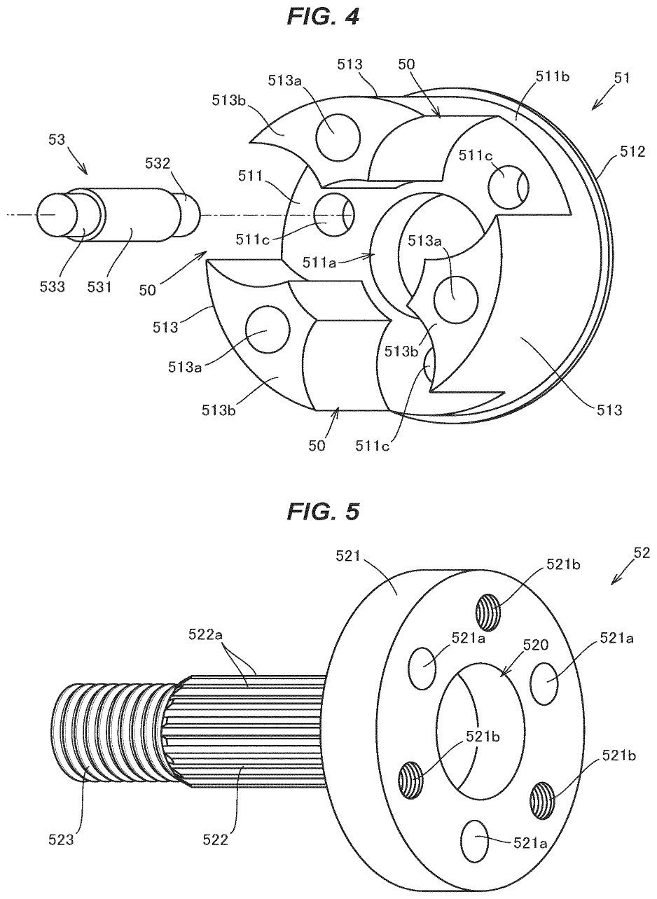

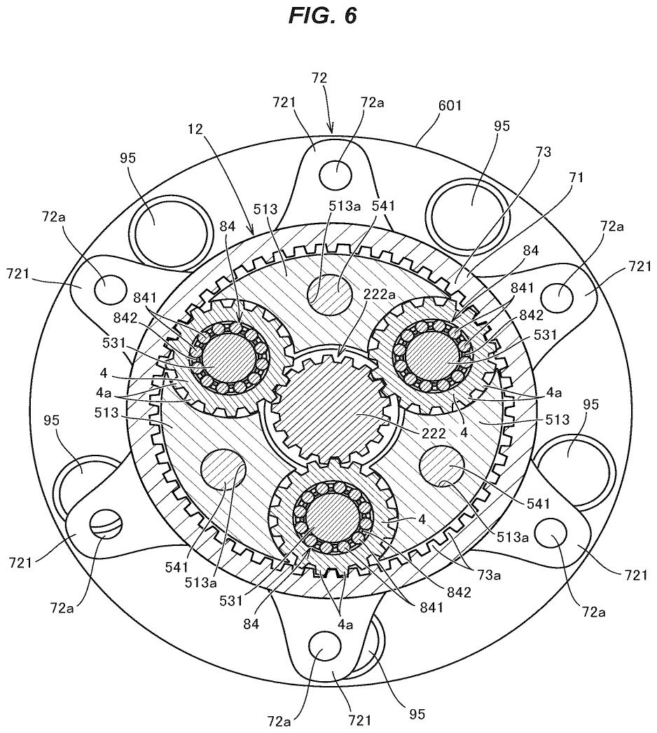

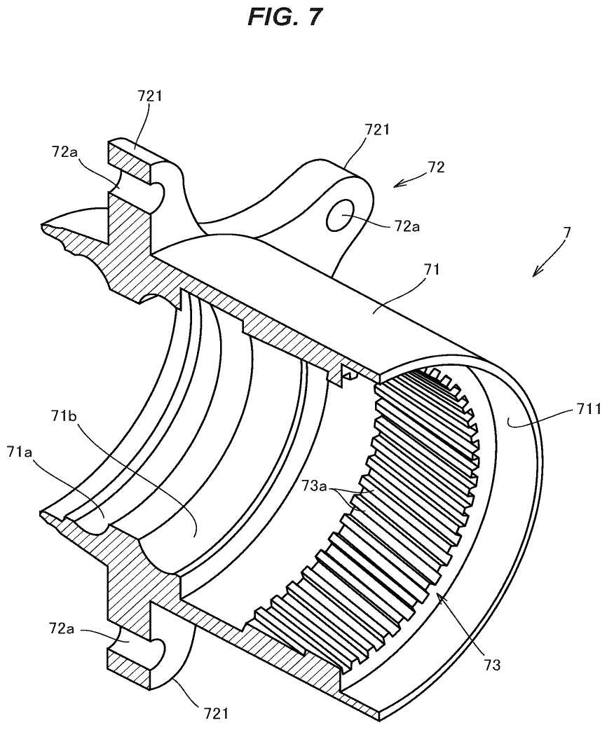

FIG. 4 is a perspective view illustrating the holding member 51 and one support shaft member 53. FIG. 5 is a perspective view illustrating the linking member 52. FIG. 6 is a cross-sectional view of the drive device 1, illustrating a cross-section of the planetary gear mechanism 12 perpendicular to the axial direction, as viewed from the vehicle inner side toward the vehicle outer side. FIG. 7 is a perspective cross-sectional view illustrating the outward member 7.

The holding member 51 integrally includes a base portion 511 that is disk-shaped, a flange portion 512 provided at an end portion of the base portion 511 on the vehicle inner side, and a plurality of leg shaft portions 513 formed and extending in the axial direction so as to protrude from the base portion 511 toward the vehicle outer side. A through hole 511a is formed in a center portion of the base portion 511, into which the shaft portion 222 of the reduction gear 22 is inserted. The flange portion 512 is formed in an annular shape and protrudes in a radial direction from an outer peripheral face 511b of the base portion 511.

The plurality of leg shaft portions 513 is provided at equal intervals along a circumferential direction of the base portion 511, and the holding portions 50 are formed between the plurality of leg shaft portions 513. In the present embodiment, the planetary gear mechanism 12 includes three planetary gears 4, and the holding member 51 is provided with three leg shaft portions 513. Each of the leg shaft portions 513 is formed with a bolt insertion hole 513a for inserting the bolt 54 therethrough. As illustrated in FIG. 2, the bolt 54 includes an insertion portion 541 that is cylindrical in shape and is inserted into the bolt insertion hole 513a, a head portion 542 that is larger in diameter than the insertion portion 541, and an external thread portion 543 that screws into the linking member 52.

The support shaft member 53 integrally includes a large diameter portion 531 that is inserted through the center portion of the planetary gear 4, and a pair of small diameter portions 532 and 533, the small diameter portions 532 and 533 being each provided on a corresponding one of both end portions of the large diameter portion 531. The base portion 511 of the holding member 51 is formed with a fitting hole 511c into which the small diameter portion 532, on the vehicle inner side of the pair of small diameter portions 532 and 533 of each of the support shaft members 53, is fit. The small diameter portion 533 on the vehicle outer side is fit into a fitting hole 521a of the linking member 52, which will be described next.

The linking member 52 integrally includes a disk-shaped cap portion 521 that closes off openings on the vehicle outer side of the plurality of holding portions 50 and suppresses the plurality of planetary gears 4 from falling out, a spline shaft portion 522 that extends from a center portion of the cap portion 521 to the vehicle outer side, and an external thread portion 523 that is provided at the end portion thereof on the vehicle outer side. A recessed portion 520 that is recessed in the axial direction toward the vehicle outer side is formed in the center portion of the cap portion 521. As illustrated in FIG. 2, the recessed portion 520 houses the bearing 83 that supports the shaft portion 222 of the reduction gear 22.

The cap portion 521 is formed with a plurality of fitting holes 521a into which the small diameter portions 533 on the vehicle outer side of the support shaft members 53 fit, and a plurality of screw holes 521b into which the external thread portions 543 of the bolts 54 screw, arrayed alternating along the circumferential direction of the cap portion 521. Distal end faces 513b of the leg shaft portions 513 abut against the cap portion 521 of the linking member 52 under axial force of the bolts 54. A plurality of spline teeth 522a extending in the axial direction is formed on an outer periphery of the spline shaft portion 522. The spline shaft portion 522 is inserted into the center portion of the inward member 6.

As illustrated in FIG. 3, the planetary gear 4 is supported on an outer peripheral side of the large diameter portion 531 of the support shaft member 53 via the bearing 84. The bearing 84 is a needle roller bearing, and includes a plurality of needle rollers 841 and a cage 842 that holds the plurality of needle rollers 841. In the present embodiment, two bearings 84 are arranged side by side in the axial direction between the large diameter portion 531 of the support shaft member 53 and the planetary gear 4.

The outward member 7 extends around an outer periphery of the planetary gear mechanism 12. An internal gear element 73 that meshes with the plurality of planetary gears 4 is provided on an inner peripheral portion of the outward member 7. The configuration of the outward member 7 will be described in detail later.

The inward member 6 is made up of a hub ring 61 having a fitting hole 60 formed in the center portion thereof, into which the spline shaft portion 522 of the linking member 52 is spline-fitted, and an inner ring 62 fit onto an end portion of the vehicle inner side of the hub ring 61. A nut 873 is screwed onto the external thread portion 523 of the linking member 52 that protrudes from the fitting hole 60 towards the vehicle outer side. The carrier 5 is connected to the inward member 6 so as not to rotate relative thereto by the spline shaft portion 522 of the linking member 52 being spline-fitted into the fitting hole 60.

The inner ring 62 is kept from falling off the hub ring 61 by being abutted by the cap portion 521 of the linking member 52 Note that the end portion of the hub ring 61 on the vehicle inner side may be crimped to keep the inner ring 62 from coming off.

The plurality of rolling elements 80 is disposed between the inward member 6 and the outward member 7 to form double rows of rolling elements. More specifically, the plurality of rolling elements 80 makes up a first rolling element row 80A on the wheel-tire assembly 91 side and a second rolling element row 80B on the planetary gear mechanism 12 side. The plurality of rolling elements 80 of the first rolling element row 80A is held in a first cage 801, and rolls on a first inner raceway face 61a formed in the hub ring 61. The plurality of rolling elements 80 of the second rolling element row 80B is held in a second cage 802 and rolls on a second inner raceway face 62a formed in the inner ring 62. In the present embodiment, the rolling elements 80 are spherical, but this is not restrictive, and the rolling elements 80 may be tapered rollers.

The inward member 6 includes a hub flange 601 to which the wheel 911 of the wheel-tire assembly 91 is attached, and a hub cylindrical portion 602 that is on an inner side of the first rolling element row 80A and the second rolling element row 80B. The hub flange 601 is a part of the hub ring 61. The hub cylindrical portion 602 is made up of part of the hub ring 61 and the inner ring 62. The first inner raceway face 61a and the second inner raceway face 62a are formed on an outer periphery of the hub cylindrical portion 602.

A hub bolt 95 for attaching a brake disc 93 and the wheel 911 of the wheel-tire assembly 91 is fixed to the hub flange 601. The hub bolt 95 is press-fit in the axial direction into a bolt hole 601a formed in the hub flange 601, and a hub nut 96 illustrated in FIG. 2 is screwed onto a distal end portion thereof. Note that alternatively, an internal threaded hole may be formed in the hub flange 601, with the hub bolt screwed into this internal threaded hole.

The outward member 7 includes a cylindrical portion 71 that fits into the attaching hole 920 of the attaching member 92, a flange portion 72 that is fixed to an opening end face 920a of the attaching hole 920 in the attaching member 92, and the internal gear element 73 that is provided inside the cylindrical portion 71. In the present embodiment, the cylindrical portion 71, the flange portion 72, and the internal gear element 73 are integrally formed.

The cylindrical portion 71 has an outside diameter that is slightly smaller than the bore diameter of the attaching hole 920, and is inserted into the attaching hole 920 from the vehicle outer side toward the vehicle inner side. A seal member 881 is disposed between an end portion of the cylindrical portion 71 on the vehicle outer side, and the hub ring 61. The cylindrical portion 71 is formed with a first outer raceway face 71a on which the plurality of rolling elements 80 of the first rolling element row 80A rolls, and a second outer raceway face 71b on which the plurality of rolling elements 80 of the second rolling element row 80B rolls.

In the present embodiment, as illustrated in FIG. 6, the flange portion 72 is made up of a plurality of flange pieces 721. The plurality of flange pieces 721 is provided radially so as to protrude outward from the cylindrical portion 71. However, the flange portion 72 may be provided in an annular shape on an outer peripheral side of the cylindrical portion 71. The attaching member 92 has threaded holes 92b formed so as to open at an opening end face 920a, into which bolts 97 for fixing the flange portion 72 are screwed. The opening end face 920a is an end face of the attaching member 92 on the vehicle outer side around an opening of the attaching hole 920. Each of the flange pieces 721 has a bolt insertion hole 72a formed at a position corresponding to the screw hole 92b. The outward member 7 is fixed to the attaching member 92 by the bolts 97 being inserted into the bolt insertion holes 72a and being screwed into the screw holes 92b.

As illustrated in FIG. 7, the internal gear element 73 is formed with a plurality of helical teeth 73a of which tooth traces are inclined relative to the axial direction. The internal gear element 73 is meshed with helical teeth 4a of the plurality of planetary gears 4. A bearing fitting portion 711 into which the bearing 85 is fit is formed at an end portion of the cylindrical portion 71 on the vehicle inner side.

The bearing 85 is a ball bearing, and as illustrated in FIG. 3, includes an outer ring 851, an inner ring 852, and a plurality of rolling elements 853 disposed between the outer ring 851 and the inner ring 852. The outer ring 851 is held by the bearing fitting portion 711 of the outward member 7. The inner ring 852 is disposed on an outer periphery of the base portion 511 of the holding member 51, and a side face thereof on the vehicle inner side faces the flange portion 512 of the holding member 51.

### Lubrication Structure of Drive Device 1

Next, a lubrication structure for lubricating each component of the drive device 1 with lubricating oil 90 will be described. The reduction gear mechanism 11, the planetary gear mechanism 12, and the hub unit 13, of the drive device 1, are lubricated by the lubricating oil 90 sealed in a space surrounded by the case 3, the outward member 7, and the attaching member 92.

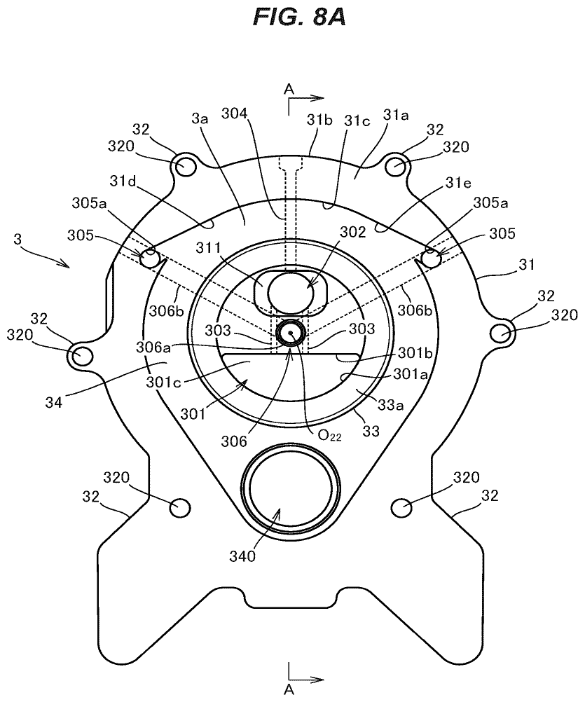

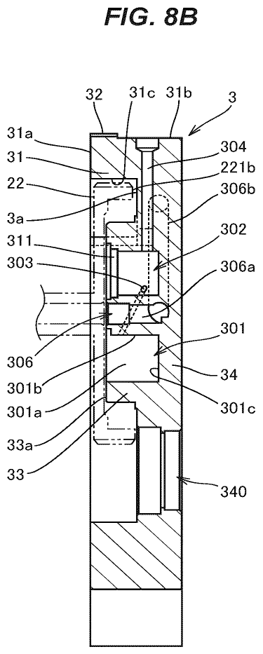

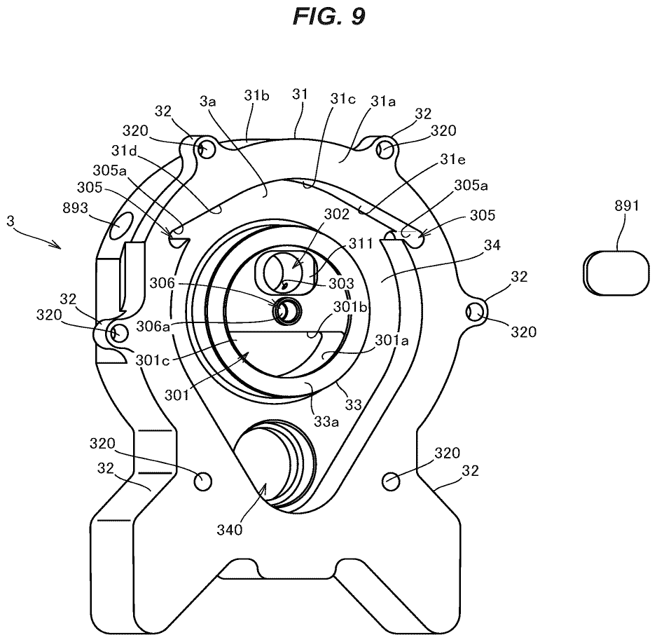

FIG. 8A is a configuration diagram illustrating a face of the case 3 on the attaching member 92 side. FIG. 8B is a cross-sectional view of the case 3, taken along line A-A in FIG. 8A. FIG. 9 is a perspective view of the case 3. In FIG. 8A and FIG. 8B, the shapes of holes and the like formed inside the case 3 are indicated by dashed lines, and in FIG. 8B, part of the reduction gear 22 combined with the case 3 is indicated by a long dashed double-short dashed line. FIG. 9 illustrates the case 3 together with a shielding plate 891 to be assembled to the case 3.

The case 3 includes an outer wall portion 31 that surrounds the pinion gear 21 and the large diameter gear portion 221 and the disk portion 223 of the reduction gear 22, and a plurality of attaching pieces 32 formed protruding outward from the outer wall portion 31. A flat face of the outer wall portion 31 on the vehicle outer side serves as an abutting face 31a that abuts against the attaching member 92. Each of the attaching pieces 32 has a bolt insertion hole 320 formed therein, into which the bolt 871 for mounting the case 3 to the attaching member 92 is inserted.

Part of the case 3 is disposed inside the large diameter gear portion 221 of the reduction gear 22. Hereinafter, this part of the case 3 will be referred to as a boss portion 33. The boss portion 33 is disk-shaped, and is centered on the rotation axis O₂₂ of the reduction gear 22, and is formed to protrude further in the vehicle outer side than a counterface 3a of the case 3 that faces an end face 221b of the large diameter gear portion 221 on the vehicle inner side. The counterface 3a is a flat face that is directed toward the vehicle outer side, and is perpendicular to the axial direction. An end face 33a of the boss portion 33 on the vehicle outer side, and the disk portion 223 of the reduction gear 22, face each other in the axial direction with a small clearance therebetween.

Hereinafter, a portion of the case 3 that is closer to the vehicle inner side than the counterface 3a will be referred to as base portion 34. The base portion 34 has a housing hole 340 formed therein that houses the output shaft 101 and the bearing 81 of the motor 10, along with part of the pinion gear 21. As illustrated in FIG. 2, a seal member 882 for preventing leakage of the lubricating oil 90 is disposed in the housing hole 340. The pinion gear 21 is disposed downward in the vertical direction from the rotation axis O₂₂ of the reduction gear 22, and a meshing portion between the small diameter gear element 21a of the pinion gear 21 and the large diameter gear element 221a of the large diameter gear portion 221 is in an oil bath of the lubricating oil 90.

As illustrated in FIG. 2, the bearing 86 is disposed between the large diameter gear portion 221 and the boss portion 33, to rotatably support the reduction gear 22 relative to the case 3. The bearing 86 includes an outer ring 861, an inner ring 862, and a plurality of rolling elements 863 disposed between the outer ring 861 and the inner ring 862. The outer ring 861 is fit to the inside of the large diameter gear portion 221. The boss portion 33 is fit inside of the inner ring 862.

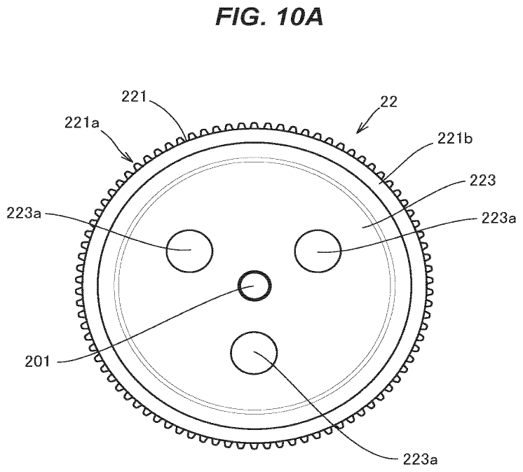

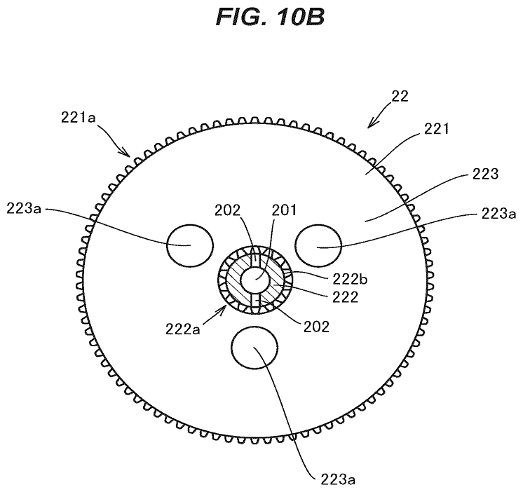

FIG. 10A is a configuration diagram illustrating a face of the reduction gear 22 on the case 3 side. FIG. 10B is a cross-sectional view of the reduction gear 22, in which a cross-section of the shaft portion 222 of the reduction gear 22 is viewed from the vehicle outer side toward the vehicle inner side.

The disk portion 223 of the reduction gear 22 is formed with a plurality of through holes 223a through which the lubricating oil 90 flows in the axial direction. In the present embodiment, three through holes 223a are formed at equal intervals in the circumferential direction. An oil hole 201 for supplying lubricating oil 90 to the outer side of the vehicle relative to the disk portion 223 is formed in the shaft portion 222 of the reduction gear 22, along the rotation axis O₂₂. Also, a plurality of discharge holes 202 communicating with the oil hole 201 is formed in the shaft portion 222. The discharge holes 202 extend in the radial direction of the shaft portion 222 and open to an outer peripheral face 222b of the shaft portion 222.

In the present embodiment, two discharge holes 202 are formed in the shaft portion 222. Also, according to the present embodiment, each of the discharge holes 202 opens to the outer peripheral face 222b of the shaft portion 222 further on the vehicle outer side than the sun gear element 222a. However, this is not restrictive, and one or three or more discharge holes 202 may be formed in the shaft portion 222. Also, the discharge holes 202 may open to, for example, a root face of the sun gear element 222a.

When the reduction gear 22 rotates, the lubricating oil 90 is discharged outward from the discharge holes 202 by centrifugal force. The lubricating oil 90 that is discharged from the discharge holes 202 lubricates each component of the planetary gear mechanism 12 and the hub unit 13. Specifically, the lubricating oil 90 is supplied to meshing portions among the planetary gears 4 and the shaft portion 222 of the reduction gear 22 and the internal gear element 73 of the outward member 7, and to the bearings 83 and 84, and the plurality of rolling elements 80.

However, for example, a sealing member may be disposed between the cap portion 521 of the linking member 52 and the cylindrical portion 71 of the outward member 7 such that only the planetary gear mechanism 12 is lubricated by the lubricating oil 90 discharged from the discharge holes 202. In this case, it is preferable to seal in grease that has a higher viscosity than the lubricating oil 90, for example, between the hub cylindrical portion 602 and the cylindrical portion 71 of the outward member 7. That is to say, it is sufficient for the lubricating oil 90 discharged from the discharge holes 202 to be supplied to at least the planetary gear mechanism 12.

The case 3 is formed with a reservoir 301 for storing the lubricating oil 90, a breather chamber 302 that is communicates with outside air, a ventilation passage 303 that communicates between the reservoir 301 and the breather chamber 302, an outside air communication hole 304 that communicates between the breather chamber 302 to the outside air, a collecting unit 305 that collects the lubricating oil 90 scooped up by rotation of the reduction gear 22, and an oil passage 306 that supplies the lubricating oil 90 collected by the collecting unit 305 to the oil hole 201 of the reduction gear 22.

Forming the reservoir 301 in the case 3 enables the amount of the lubricating oil 90 inside the drive device 1 to be increased, thereby enabling deterioration of the lubricating oil 90 to be suppressed even after long-term use, and further, fluctuation in the height of the oil level 90a illustrated in FIG. 2 can be suppressed even when the lubricating oil 90 is scooped up by rotation of the reduction gear 22. Also, the reservoir 301 communicates with the breather chamber 302, and accordingly when the temperature inside the case 3 and the outward member 7 in the drive device 1 rises, expanded air is released to outside of the case 3 through the breather chamber 302 and the outside air communication hole 304, thereby enabling decrease in sealing abilities of the seal members 881 and 882 due to increase in internal pressure to be prevented.

The reservoir 301 is formed closer to the motor 10 than the disk portion 223 of the reduction gear 22 in the axial direction of the drive device 1, and is open toward the disk portion 223. The plurality of through holes 223a of the disk portion 223 is formed at positions where at least parts thereof are aligned in the axial direction with the reservoir 301 and communicate therewith when the reduction gear 22 rotates. This configuration enables the lubricating oil 90 to flow between the portion of disk portion 223 that is closer to the vehicle outer side and the reservoir 301, via the plurality of through holes 223a of the disk portion 223.

As illustrated in FIG. 8A, the reservoir 301 is formed downward from the rotation axis O₂₂ of the reduction gear 22, and has a partially circular shape when viewed from the vehicle outer side along the rotation axis O₂₂. An inner face of the reservoir 301 is formed of an arc-shaped face 301a, which, when viewed from the axial direction, is arc-shaped with the rotation axis O₂₂ as the center thereof, a flat face 301b, which, when viewed from the axial direction, is linear and connects both end portions of the arc-shaped face 301a, and a bottom face 301c that is perpendicular to the axial direction. The flat face 301b is a level face that is horizontal.

Part of the reservoir 301 is formed in the boss portion 33, and another part thereof is formed in the base portion 34. That is to say, in the present embodiment, the reservoir 301 is formed spanning the boss portion 33 and the base portion 34. However, the reservoir 301 may be formed just in the boss portion 33.

The breather chamber 302 is formed upward from the reservoir 301. The breather chamber 302 has a circular shape as viewed from the vehicle outer side along the rotation axis O₂₂. In the present embodiment, the breather chamber 302 is formed upward from the rotation axis O₂₂ of the reduction gear 22, and the reservoir 301 and the breather chamber 302 are in communication with each other via two ventilation passages 303. As illustrated in FIG. 8B, the ventilation passages 303 are formed inclined with respect to an up-down-direction. This enables the ventilation passages 303 to be formed by inserting a cutting tool such as a drill or the like through an opening of the reservoir 301 when manufacturing the case 3.

The outside air communication hole 304 is formed further upward from the breather chamber 302. In the present embodiment, the outside air communication hole 304 is formed to extend in the vertical direction from an upper end portion of the breather chamber 302, and open to the outer peripheral face 31b of the outer wall portion 31 of the case 3. As illustrated in FIG. 2, the outside air communication hole 304 houses a filter 892 that is breathable and that has waterproof property.

The breather chamber 302 is formed recessed in a direction parallel to the rotation axis O₂₂ of the reduction gear 22, from the end face 33a of the boss portion 33, which is the counterface that faces the disk portion 223 of the case 3. An opening on the disk portion 223 side of the breather chamber 302 is partially shielded by the shielding plate 891, which prevents lubricating oil 90 that is flying from directly splashing on the outside air communication hole 304, and also prevents large bubbles from entering the breather chamber 302. As illustrated in FIG. 9, the boss portion 33 is formed with a stepped recessed portion 311 around the opening of the breather chamber 302, and the shielding plate 891 is fit into this stepped recessed portion 311. The stepped recessed portion 311 and the shielding plate 891 have a rounded rectangular shape as viewed along the rotation axis O₂₂. The shielding plate 891 may be fixed to the case 3 by press-fitting into the stepped recessed portion 311, or may be fixed to the case 3 by welding, crimping, or bolting, for example.

The collecting unit 305 is a recessed portion formed by cutting out a part of the outer wall portion 31 so as to open along the rotation direction of the reduction gear 22. In the present embodiment, a pair of the collecting units 305 are formed in the case 3 so as to be able to efficiently collect the lubricating oil 90 scooped up by the rotation of the reduction gear 22 in both a forward direction, which is the rotation direction of the reduction gear 22 when the vehicle is moving forward, and a reverse direction, which is the rotation direction of the reduction gear 22 when the vehicle is moving backward.

As illustrated in FIG. 8A and FIG. 9, an inner face of the outer wall portion 31 includes an arc-shaped inner face 31c centered on the rotation axis O₂₂ of the reduction gear 22, a first inclined face 31d extending from one end portion of the arc-shaped inner face 31c, toward one of the collecting units 305 and continuing to an inner face 305a of the one collecting unit 305, and a second inclined face 31e extending from the other end portion of the arc-shaped inner face 31c toward the other collecting unit 305 and continuing to an inner face 305a of the other collecting unit 305. The arc-shaped inner face 31c is formed upward from the pair of collecting units 305. The first and second inclined faces 31d and 31e are inclined downwards as the first and second inclined faces 31d and 31e extend toward the collecting units 305.

When the reduction gear 22 rotates, the large diameter gear portion 221 scoops up the lubricating oil 90, and the lubricating oil 90 that is scooped up adheres to the arc-shaped inner face 31c and the first and second inclined faces 31d and 31e, and the lubricating oil 90 adhered thereto flows down the first and second inclined faces 31d and 31e and into one or the other of the pair of collecting units 305. As a result, the lubricating oil 90 is collected in the collecting units 305.

The lubricating oil 90 collected in the collecting units 305 is supplied to the oil hole 201 of the reduction gear 22 through the oil passage 306. The oil passage 306 is made of an axial direction hole 306a that is aligned in the axial direction with the oil hole 201 of the reduction gear 22 along the rotation axis O₂₂ of the reduction gear 22, and a pair of radial direction holes 306b that respectively communicate between the axial direction hole 306a and the pair of collecting units 305.

The axial direction hole 306a faces the oil hole 201 of the reduction gear 22 at an end portion thereof on the vehicle outer side, and communicates with the pair of radial direction holes 306b at an end portion thereof on the vehicle inner side. The pair of radial direction holes 306b are formed from the outer peripheral face 31b of the outer wall portion 31 toward the axial direction hole 306a. As illustrated in FIG. 9, the end portion of the axial direction hole 306a on the outer peripheral face 31b side of the outer wall portion 31 is closed off by a plug 893.

The lubricating oil 90 supplied to the oil hole 201 of the reduction gear 22 is discharged from the discharge holes 202 as described above, to lubricate each component of the planetary gear mechanism 12, for example, flows downward between the carrier 5 and the cylindrical portion 71 of the outward member 7, and is again scooped up by the rotation of the reduction gear 22. By circulating the lubricating oil 90 in this manner, sliding between each of the members becomes smoother, and generation of heat at the meshing portions is also suppressed.

### Effects of Embodiment

According to the present embodiment described above, the reservoir 301 is formed in the boss portion 33, which is part of the case 3 disposed inside the large diameter gear portion 221 of the reduction gear 22, such that the amount of lubricating oil 90 in the drive device 1 can be increased while suppressing the case 3 from becoming larger. That is to say, effectively utilizing dead space inside the large diameter gear portion 221 as part of the reservoir 301 enables the drive device 1 to be made smaller and lighter.

Also, according to the present embodiment, the breather chamber 302 is formed upward from the reservoir 301, and accordingly foreign matter can be suppressed from contaminating the lubricating oil 90 while preventing increase in pressure inside the case 3 and the outward member 7.

Furthermore, according to the present embodiment, the collecting units 305 and the oil passage 306 are formed in the case 3, and accordingly the lubricating oil 90 scooped up by the rotation of the reduction gear 22 can be efficiently supplied to the planetary gear mechanism 12.

### Modification

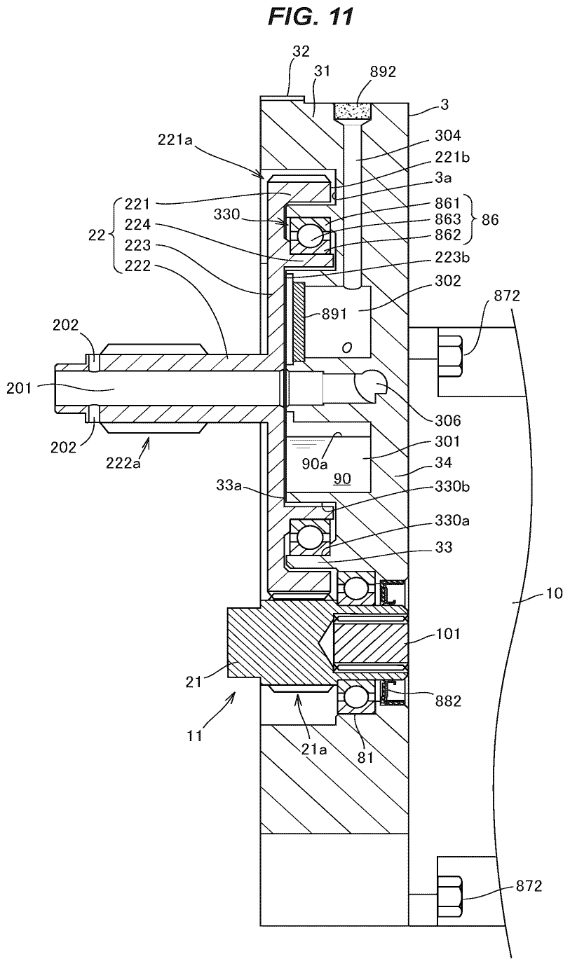

Next, a modification of the drive device will be described with reference to FIG. 11. In this modification, the shapes of the case 3 and the reduction gear 22 are different from those of the above embodiment, and the rest of the configuration is the same as that of the above embodiment. FIG. 11 illustrates the case 3, the reduction gear mechanism 11, and the motor 10, according to the modification, and does not illustrate other members. Also, in FIG. 11, members that are the same as those in the above embodiment are denoted by the same reference numerals as those in FIG. 2.

In the above embodiment, a case has been described in which the outer ring 861 of the bearing 86 is fit inside the large diameter gear portion 221 and rotates together with the reduction gear 22, and the boss portion 33 is fit inside the inner ring 862 of the bearing 86, however, in the present modification, the outer ring 861 of the bearing 86 is fixed to the boss portion 33, and the inner ring 862 of the bearing 86 is configured to rotate together with the reduction gear 22.

The reduction gear 22 integrally includes the large diameter gear portion 221, the shaft portion 222, the disk portion 223, and an annular projection 224 that is fit to the inner side of the inner ring 862. The annular projection 224 projects in the axial direction toward the vehicle inner side, from a counterface 223b of the disk portion 223 that faces the boss portion 33.

The boss portion 33 of the case 3 is formed with a recessed portion 330 that is annular in shape and is centered on the rotation axis O22 of the reduction gear 22. The recessed portion 330 houses the bearing 86 and the annular projection 224 of the reduction gear 22. The outer ring 861 is fitted to an inner peripheral face 330a on an outside diameter side of the recessed portion 330. A clearance is formed between an outer peripheral face 330b on a bore diameter side of the recessed portion 330 and the annular projection 224.

This modification also provides the same effects as the above embodiment.

### Additional Notes

Although the present invention has been described above based on the embodiment and the modifications, the embodiment and the modifications are not intended to limit the invention according to the claims. It should also be noted that the combinations of features described in the embodiment and the modifications are not necessarily all essential to means for solving the problem in the invention.

The present invention can also be implemented with modifications made as appropriate by omitting, adding, or replacing part of the components without departing from the spirit and scope thereof. For example, in the above embodiment, a case has been described in which the shaft portion 222 of the reduction gear 22 making up the reduction gear mechanism 11 protrudes from the case 3 and is housed in the outward member 7, but this is not limiting, and the entire reduction gear 22 may be housed in the case 3. That is to say, it is sufficient for the case 3 to house at least part of the reduction gear mechanism 11.

### REFERENCE SIGNS LIST

1 DRIVE DEVICE
10 MOTOR
11 REDUCTION GEAR MECHANISM
12 PLANETARY GEAR MECHANISM
201 OIL HOLE
202 DISCHARGE HOLE
21 PINION GEAR (INPUT GEAR)
22 REDUCTION GEAR (OUTPUT GEAR)
221 LARGE DIAMETER GEAR PORTION
222 SHAFT PORTION
223 DISK PORTION
223a THROUGH HOLE
3 CASE
301 RESERVOIR
302 BREATHER CHAMBER
303 VENTILATION PASSAGE
305 COLLECTING UNIT
306 OIL PASSAGE
33 BOSS PORTION (PART OF CASE 3)
4 PLANETARY GEAR
86 BEARING
90 LUBRICATING OIL
891 SHIELDING PLATE

1. A vehicle drive device for driving a wheel-tire assembly of a vehicle, comprising:
a motor,
a reduction gear mechanism lubricated by lubricating oil; and
a case that houses at least part of the reduction gear mechanism,
wherein the reduction gear mechanism comprises an input gear and an output gear,
wherein the output gear comprises a large diameter gear portion having a cylindrical shape with a diameter larger than a diameter of the input gear, a shaft portion having an outside diameter smaller than an outside diameter of the large diameter gear portion, and a disk portion provided between the large diameter gear portion and the shaft portion,
wherein the input gear is meshed with the large diameter gear portion,
wherein part of the case is disposed on an inner side of the large diameter gear portion, and
wherein a reservoir that stores the lubricating oil is provided in the part of the case,
wherein a rotation axis of the input gear and a rotation axis of the output gear are parallel to each other,
wherein the reservoir is provided closer to the motor side than the disk portion is, in an axial direction parallel to the rotation axis of the output gear, and
wherein the reservoir opens toward the disk portion.

2. (canceled)

3. The vehicle drive device according to claim 1, wherein the disk portion has a plurality of through holes through which the lubricating oil is made to flow in the axial direction.

4. The vehicle drive device according to claim 1, wherein a bearing that rotatably supports the output gear with respect to the case is disposed between the large diameter gear portion and the part of the case.

5. The vehicle drive device according to claim 1, wherein the input gear is disposed downward from a rotation axis of the output gear in a vertical direction, and
wherein a meshing portion between the input gear and the large diameter gear portion of the output gear is in an oil bath of the lubricating oil.

6. The vehicle drive device according to claim 1, wherein an oil hole for supplying the lubricating oil toward the wheel-tire assembly relative to the disk portion is provided in the shaft portion, along a rotation axis of the output gear, and
wherein the case is provided with a collecting unit that collects the lubricating oil scooped up by rotation of the output gear, and an oil passage that supplies the lubricating oil collected by the collecting unit to the oil hole.

7. The vehicle drive device according to claim 6, further comprising a planetary gear mechanism including a plurality of planetary gears,
wherein the plurality of planetary gears is disposed on an outer periphery of the shaft portion,
wherein a discharge hole that communicates with the oil hole is provided in the shaft portion, and
wherein the lubricating oil discharged from the discharge hole is supplied to the planetary gear mechanism.

8. The vehicle drive device according to claim 1, wherein the case is provided with a breather chamber that is in communication with outside air and that is provided upward from the reservoir in a vertical direction, and also is provided with a ventilation passage that communicates between the reservoir and the breather chamber.

9. The vehicle drive device according to claim 8, wherein the breather chamber is provided so as to be recessed from a counterface that faces the disk portion of the case, in a direction parallel to a rotation axis of the output gear, and an open end portion on the disk portion side is closed off by a shielding plate.
